(19) United States
(12) Patent Application Publication
(10) Pub. No.: US 2008/0305302 A1
(43) Pub. Date: Dec. 11, 2008

(54) Low Reflection Film and Forming Method

(75) Inventors: Chang-Jian Weng, Chiayi City (TW); Chin-Sung Chen, Jhongli City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: DAXON TECHNOLOGY INC., Gueishan Township (TW)

(21) Appl. No.: 12/129,970

(22) Filed: May 30, 2008

(30) Foreign Application Priority Data
Jun. 8, 2007 (TW) 96120658

(51) Int. Cl. D06N 7/04; B05D 5/06

(52) U.S. Cl. 428/149; 427/164

(57) ABSTRACT

A low reflection film and the forming method for making the same are disclosed. The low reflection film includes at least one siloxane resin and a plurality of silicon dioxide particles. The siloxane resin has at least two alkoxylates. The silicon dioxide particles are fixed by the siloxane resin and protrude from the surface of the siloxane resin. The method includes preparing a first solution by adding a first solvent to a mixture of a catalyst and a siloxane resin after sol-gel reaction, preparing a second solution by mixing the first solution with silicon dioxide particles, coating the second solution onto a surface, and performing a drying process to form the low reflection film.

### BACKGROUND OF THE INVENTION

The present invention relates to a low reflection film. More specifically, the present invention relates to a low reflection film for reducing light reflection in an optical element or the display of a monitor device.

Light reflection is one of the major reasons in deciding the displaying effect of an optical element or a monitor. A monitor having a lower reflective index can raise the displaying quality thereof. Hence, most optical elements and monitors use anti-reflection films to reduce the reflective intensity.

Reflections are caused mainly when an incident light passes through media which have different refractive indices, and part of the incident light is bounced back at the borders of different media.

One of well-known low reflection films is fluoride film. The refractive index of the fluoride film is lower than the substrate thereof, and the phase difference of the reflected light reflected from the fluoride film would reach at 180 degrees. This results in a destructive interference between the reflected lights which reflected from the interface of the fluoride film, hence reduces reflection. However, a homogeneous fluoride film formed on a larger substrate is not easy to be obtained by an evaporating method.

TW Patent No. 91136165 discloses a low reflection film having nano structure. The reflective index would be varied by the nano structure existing in the surface of the reflection film. However, the manufacturing process and the cost of the low reflection film are more complicated and higher respectively. Another low reflection film is disclosed by U.S. Pat. No. 6,472,012. The low reflection film would be treated at 420° C. while being manufactured, and is not suitable to be applied to a polarizer.

### SUMMARY OF THE INVENTION

An embodiment of the present invention provides a low reflection film having a low reflective index.

Another embodiment of the present invention provides a method for making the low reflection film.

The low reflection film of the present invention includes at least one siloxane resin and a plurality of silicon dioxide particles. The siloxane resin has at least two alkoxylates. The silicon dioxide particles are fixed by the siloxane resin and protrude from the surface of the siloxane resin. The silicon dioxide particles have diameters between 5 to 150 nm. The weight ratio of the siloxane resin to the silicon dioxide particles is 4-71:96-29.

The method for making the low reflection film includes: preparing a first solution; preparing a second solution; coating the second solution onto a first surface; and performing a drying process to form the low reflection film. The first solution is prepared by adding a first solvent to a mixture of a catalyst and at least one precursor of siloxane resin after sol-gel reaction. The second solution is prepared by mixing the first solution with a plurality of silicon dioxide particles. Wherein, the method of mixing the first solution with silicon dioxide particles further includes mixing the first solution with a solution of silicon dioxide particles. The method further includes adding the first solvent to the solution of silicon dioxide particles.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exemplary low reflection film in accordance with an embodiment of the present invention.

FIG. 2 is an exemplary flow chart of making the low reflection film in accordance with an embodiment of the present invention.

### DETAILED DESCRIPTION OF THE INVENTION

The present invention provides a low reflection film and the method for making the low reflection film.

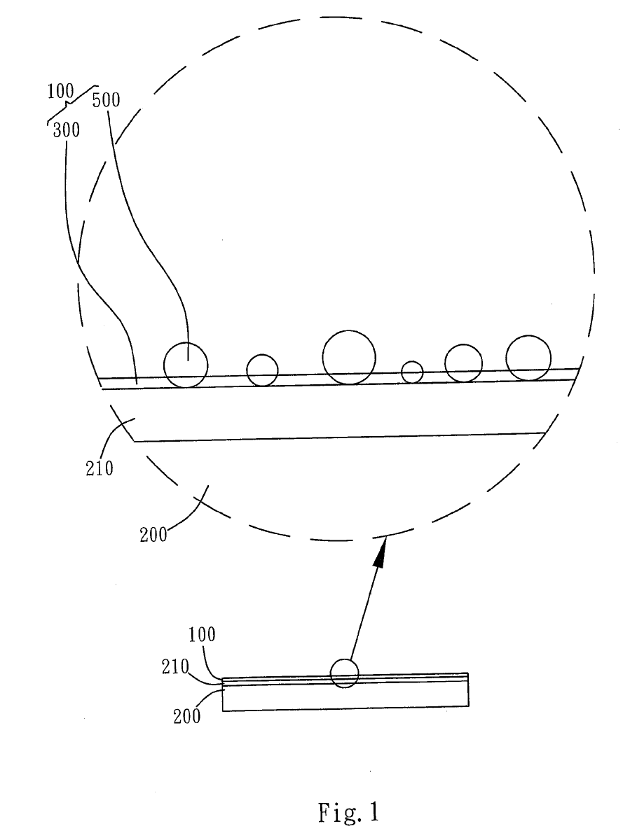

FIG. 1 is a preferred embodiment of the present invention. The low reflection film 100 of the present invention includes at least one type of siloxane resin 300 and a plurality of silicon dioxide particles 500. The silicon dioxide particles 500 are fixed in place by the siloxane resin 300 and protrude from the surface of the siloxane resin. In this preferred embodiment, the low reflection film 100 is coated on a hard coating layer 210, and the hard coating layer 210 is coated on a transparent material 200 made of tri-acetyl cellulose (TAC). However, in a different embodiment, the low reflection film can be coated on different substrates made of materials selected from polyethylene terephthalate (PET), poly-methyl methacrylate (PMMA), poly-carbonate (PC), poly-styrene (PS), or combinations thereof. Light transparent material such as glass can also be used.

Silicon dioxide particles 500 are transparent. In a preferred embodiment, diameters of the silicon dioxide particles 500 are between 50 to 100 nm. However, in a different embodiment, diameters of the silicon dioxide particles can be between 5 to 150 nm. In a prefer embodiment, the weight ratio of the siloxane resin 300 to the silicon dioxide particles 500 is 13-54:87-46. However, in a different embodiment, the weight ratio of the siloxane resin 300 to the silicon dioxide particles 500 can be 4-71:96-29.

The siloxane resin 300 includes at least two alkoxylates. The siloxane resin 300 is selected from the group consisting of methyl trimethoxy silane, methyl triethoxy silane, ethyl trimethoxy silane, ethyl triethoxy silane, n-propyl trimethoxy silane, n-propyl triethoxy silane, isopropyl trimethoxy silane, isopropyl triethoxy silane, vinyl trimethoxy silane, vinyltriethoxy silane, 3-glycidoxy propyl trimethoxy silane, 3-glycidoxy propyl triethoxy silane, 3-mercapto propyl trimethoxy silane, 3-mercapto propyl triethoxy silane, phenyl trimethoxy silane, phenyl triethoxy silane, 3,4-epoxy cyclohexyl ethyl trimethoxy silane, 3,4-epoxy cyclohexyl ethyl triethoxy silane, dimethyl dimethoxy silane, diethyl diethoxy silane, trifluoro propyl trimethoxy silane, trifluoro propyl triethoxy silane, tridecafluoro octyl trimethoxy silane, tridecafluoro octyl triethoxy silane, heptadeca fluoridecyl trimethoxy silane, heptadeca fluoridecyl triethoxy silane, and combinations thereof, preferably the ones with fluoride. In a preferred embodiment, trifluoro propyl trimethoxy silane is selected as the siloxane resin 300.

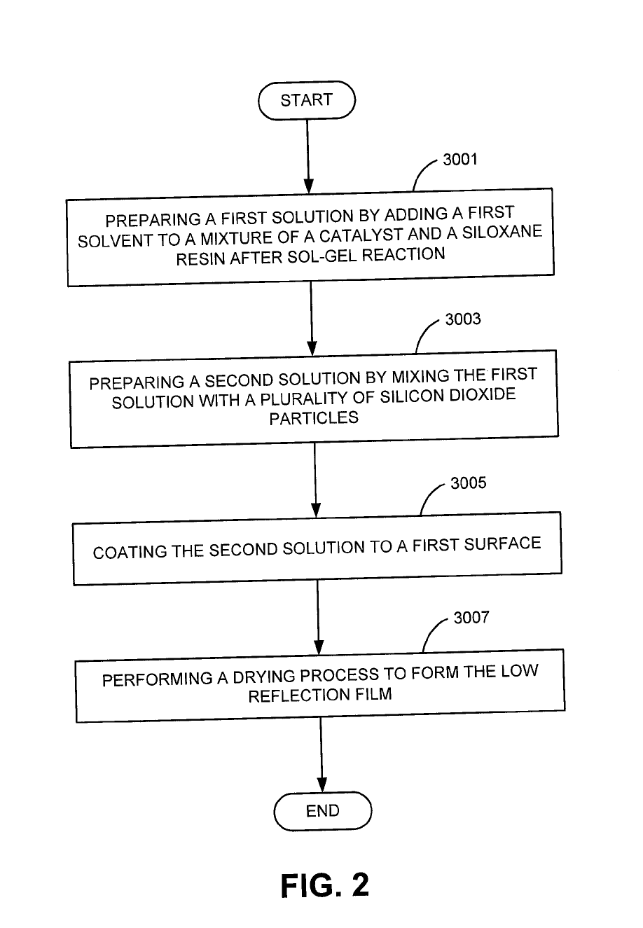

FIG. 2 shows a flow chart for making the low reflection film. Step 3001 includes preparing a first solution. First, a catalyst and a precursor of siloxane resin are mixed. After the mixture performs a sol-gel reaction, the first solution is obtained by adding a first solvent. Besides, the catalyst includes an acid or a base. In a preferred embodiment, the catalyst is hydrogen chloride (HCl).

The siloxane resin includes at least two alkoxylates and is selected from the group consisting of methyl trimethoxy silane, methyl triethoxy silane, ethyl trimethoxy silane, ethyl triethoxy silane, n-propyl trimethoxy silane, n-propyl triethoxy silane, isopropyl trimethoxy silane, isopropyl triethoxy silane, vinyl trimethoxy silane, vinyltriethoxy silane, 3-glycidoxy propyl trimethoxy silane, 3-glycidoxy propyl triethoxy silane, 3-mercapto propyl trimethoxy silane, 3-mercapto propyl triethoxy silane, phenyl trimethoxy silane, phenyl triethoxy silane, 3,4-epoxy cyclohexyl ethyl trimethoxy silane, 3,4-epoxy cyclohexyl ethyl triethoxy silane, dimethyl dimethoxy silane, diethyl diethoxy silane, trifluoro propyl trimethoxy silane, trifluoro propyl triethoxy silane, tridecafluoro octyl trimethoxy silane, tridecafluoro octyl triethoxy silane, heptadeca fluoridecyl trimethoxy silane, heptadeca fluoridecyl triethoxy silane, and combinations thereof, preferably the ones with fluoride. In a preferred embodiment, trifluoro propyl trimethoxy silane is selected as the siloxane resin.

The first solvent is selected from the group consisting of isopropyl alcohol, n-butanol, i-butanol, t-butanol, methyl ethyl ketone, methyl isobutyl ketone, ethylene glycol monomethyl ether, ethylene glycol monoethyl ether, diethylene glycol monomethyl ether, diethylene glycol monoethyl ether, propylene glocol monoethyl ether, and combinations thereof. In a preferred embodiment, isopropyl alcohol (IPA) is selected as the first solvent.

Step 3003 includes preparing a second solution. The second solution is prepared by mixing the first solution and silicon dioxide particles. The silicon dioxide particles 500 are transparent. In a preferred embodiment, diameters of the silicon dioxide particles 500 are between 50 to 100 nm. However, in a different embodiment, diameters of the silicon dioxide particles 500 can be between 5 to 150 nm. Silicon dioxide particles can be mixed with the first solution directly; however, it can also be mixed by mixing the first solution with a solution of silicon dioxide particles. In a preferred embodiment, the solution of silicon dioxide particles can be added into the first solvent.

Step 3005 includes coating the second solution to a surface. In a preferred embodiment, coating of the second solution is done using meyer bar coating. However, in a different embodiment, coating of the second solution can be done using spin coating, dip coating, or spray coating. Step 3007 includes performing a drying process to form the low reflection film. In a preferred embodiment, the drying process is done by using an oven. However, other drying processes such as air dry or use of vacuum desiccators can also be adopted.

### EXAMPLES OF PERFORMING THE INVENTION

Followings are embodiments of the method and steps for making the low reflection film.

### Example 1

3 grams of tetraethyl orthosilicate, 1 gram of methyl triethoxy silane, 0.02 grams of 1N hydrogen chloride, and 3 grams of pure water are mixed and stirred at room temperature for 30 minutes for sol-gel reaction, then 5 grams of isopropyl alcohol (IPA) are added after mixing, so as to obtain a first solution. Then, 10 grams of silicon dioxide particles solution with diameters between 70 to 100 nm are mixed with 30 grams of isopropyl alcohol (IPA), and the first solution is added and stirred for 3 hours after mixing, so as to obtain a second solution. Coating a mixture of 1 gram of the second solution and 5 grams of isopropyl alcohol (IPA) onto the surface of a substrate then baking in an oven at 100° C. After 5 minutes, the low reflection film is formed on the surface of the substrate.

### Example 2

2.16 grams of tetraethyl orthosilicate, 2 grams of methyl triethoxy silane, 0.02 grams of 1N hydrogen chloride, and 3 grams of pure water are mixed and stirred at room temperature for 1 hour for sol-gel reaction, then 15 grams of isopropyl alcohol are added after mixing, so as to obtain an A solution. 2.61 grams of trifluoro propyl trimethoxy silane, 13 grams of isopropyl alcohol, 1 gram of pure water, and 0.06 grams of 1N hydrogen chloride are mixed at room temperature for 1 hour, so as to obtain a B solution. Preparing a first solution by mixing the A solution and the B solution, and allow the mixture to react at 60° C. for 3 hours. Then, a second solution is prepared by mixing 1.5 grams of the first solution with a mixture of 3 grams of silicon dioxide particles and 10 grams of isopropyl alcohol. Next, the second solution is coated on the surface of a substrate to be put in an oven at 100° C. After 2 minutes, the low reflection film is formed on the surface of the substrate after being removed from the oven.

While the invention has been described with reference to exemplary embodiments, it is to be understood by those skilled in the art that various changes may be made and equivalents substituted for elements thereof without departing from the scope of the invention. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A low reflection film, comprising:
at least one siloxane resin; and
a plurality of silicon dioxide particles;
wherein the siloxane resin has at least two alkoxylates, and the silicon dioxide particles are fixed by the siloxane resin and protrude from the surface of the siloxane resin.

2. The low reflection film of claim 1, wherein the siloxane resin is selected from the group consisting of methyl trimethoxy silane, methyl triethoxy silane, ethyl trimethoxy silane, ethyl triethoxy silane, n-propyl trimethoxy silane, n-propyl triethoxy silane, isopropyl trimethoxy silane, isopropyl triethoxy silane, vinyl trimethoxy silane, vinyltriethoxy silane, 3-glycidoxy propyl trimethoxy silane, 3-glycidoxy propyl triethoxy silane, 3-mercapto propyl trimethoxy silane, 3-mercapto propyl triethoxy silane, phenyl trimethoxy silane, phenyl triethoxy silane, 3,4-epoxy cyclohexyl ethyl trimethoxy silane, 3,4-epoxy cyclohexyl ethyl triethoxy silane, dimethyl dimethoxy silane, diethyl diethoxy silane, trifluoro propyl trimethoxy silane, trifluoro propyl triethoxy silane, tridecafluoro octyl trimethoxy silane, tridecafluoro octyl triethoxy silane, heptadeca fluoridecyl trimethoxy silane, heptadeca fluoridecyl triethoxy silane, and combinations thereof.

3. The low reflection film of claim 1, wherein the plurality of silicon dioxide particles are transparent.

4. The low reflection film of claim 1, wherein the diameters of the plurality of silicon dioxide particles are between 5 to 150 nm.

5. The low reflection film of claim 1, wherein the weight ratio of the siloxane resin to the plurality of silicon dioxide particles is 4-71: 96-29.

6. A method for making a low reflection film, comprising:
preparing a first solution by adding a first solvent to a mixture of a catalyst and at least one precursor of siloxane resin after sol-gel reaction;
preparing a second solution by mixing the first solution with a plurality of silicon dioxide particles;
coating the second solution onto a first surface; and
performing a drying process to form the low reflection film;
wherein the siloxane resin has at least two alkoxylates, and the silicon dioxide particles are fixed by the siloxane resin and protrude from the surface of the siloxane resin.

7. The method of claim 6, wherein the step of mixing the first solution and the plurality of silicon dioxide particles further comprises mixing the first solution with a solution of the plurality of silicon dioxide particles.

8. The method of claim 7 further comprising adding the first solution to the solution of silicon dioxide particles.

9. The method of claim 6, wherein the siloxane resin is selected from the group consisting of methyl trimethoxy silane, methyl triethoxy silane, ethyl trimethoxy silane, ethyl triethoxy silane, n-propyl trimethoxy silane, n-propyl triethoxy silane, isopropyl trimethoxy silane, isopropyl triethoxy silane, vinyl trimethoxy silane, vinyltriethoxy silane, 3-glycidoxy propyl trimethoxy silane, 3-glycidoxy propyl triethoxy silane, 3-mercapto propyl trimethoxy silane, 3-mercapto propyl triethoxy silane, phenyl trimethoxy silane, phenyl triethoxy silane, 3,4-epoxy cyclohexyl ethyl trimethoxy silane, 3,4-epoxy cyclohexyl ethyl triethoxy silane, dimethyl dimethoxy silane, diethyl diethoxy silane, trifluoro propyl trimethoxy silane, trifluoro propyl triethoxy silane, tridecafluoro octyl trimethoxy silane, tridecafluoro octyl triethoxy silane, heptadeca fluoridecyl trimethoxy silane, heptadeca fluoridecyl triethoxy silane, and combinations thereof.

10. The method of claim 6, wherein the catalyst comprises acid or alkali materials.

11. The method of claim 6, wherein the first solvent is selected from the group consisting of isopropyl alcohol, n-butanol, i-butanol, t-butanol, methyl ethyl ketone, methyl isobutyl ketone, ethylene glycol monomethyl ether, ethylene glycol monoethyl ether, diethylene glycol monomethyl ether, diethylene glycol monoethyl ether, propylene glocol monoethyl ether, and combinations thereof.

12. The method of claim 6, wherein the plurality of silicon dioxide particles are transparent.

13. The method of claim 6, wherein the diameters of the plurality of silicon dioxide particles are between 5 to 150 nm.

14. The method of claim 6, wherein the weight ratio of the siloxane resin and the plurality of silicon dioxide particles is 4-71: 96-29.

15. A transparent optical film, comprising a low reflection film, wherein the low reflection film includes a siloxane resin and a plurality of silicon dioxide particles, wherein the siloxane resin has at least two alkoxylates, and the silicon dioxide particles are fixed by the siloxane resin and protrude from the surface of the siloxane resin.

16. The transparent optical film of claim 15, wherein the siloxane resin is selected from the group consisting of methyl trimethoxy silane, methyl triethoxy silane, ethyl trimethoxy silane, ethyl triethoxy silane, n-propyl trimethoxy silane, n-propyl triethoxy silane, isopropyl trimethoxy silane, isopropyl triethoxy silane, vinyl trimethoxy silane, vinyltriethoxy silane, 3-glycidoxy propyl trimethoxy silane, 3-glycidoxy propyl triethoxy silane, 3-mercapto propyl trimethoxy silane, 3-mercapto propyl triethoxy silane, phenyl trimethoxy silane, phenyl triethoxy silane, 3,4-epoxy cyclohexyl ethyl trimethoxy silane, 3,4-epoxy cyclohexyl ethyl triethoxy silane, dimethyl dimethoxy silane, diethyl diethoxy silane, trifluoro propyl trimethoxy silane, trifluoro propyl triethoxy silane, tridecafluoro octyl trimethoxy silane, tridecafluoro octyl triethoxy silane, heptadeca fluoridecyl trimethoxy silane, heptadeca fluoridecyl triethoxy silane, and combinations thereof.

17. The transparent optical film of claim 15, wherein the plurality of silicon dioxide particles are transparent.

18. The transparent optical film of claim 15, wherein the diameters of the plurality of silicon dioxide particles are between 5 to 150 nm.

19. The transparent optical film of claim 15, wherein the weight ratio of the siloxane resin and the plurality of silicon dioxide particles is 4-71: 96-29.
